(19) United States
(12) Patent Application Publication
(10) Pub. No.: US 2026/0187606 A1
(43) Pub. Date: Jul. 2, 2026

(54) SYSTEM AND METHOD FOR CREATING USER GENERATED FLEXIBLE TOKENS

(71) Applicant: American Express Travel Related Services Company, Inc., New York, NY (US)

(72) Inventors: Andras L. FERENCZI, Scottsdale, AZ (US); Alaric M. EBY, Scottsdale, AZ (US)

(73) Assignee: American Express Travel Related Services Company, Inc., New York, NY (US)

(21) Appl. No.: 19/005,500

(22) Filed: Dec. 30, 2024

(51) Int. Cl. G06Q 20/06; G06Q 20/38

(52) U.S. Cl. CPC G06Q 20/06; G06Q 20/38215; G06Q 20/3829

(57) ABSTRACT

Disclosed herein are system, method, and computer program product embodiments for increasing computer, network, and data security via user generated tokens including zero-knowledge proofs within an agentic architecture. A client device may utilize an autonomous agent to communicate with an autonomous agent at a merchant device to identify whether the merchant device is selling a desired product. A client device may generate a token including the product, a merchant identifier, purchase amount, timestamp, and zero-knowledge proof. The client device may sign the token using an encryption key. The agent at the client device may transmit the signed token to the agent at the merchant device identified via the merchant identifier. The client device may receive a result indicating whether the token and zero-knowledge proof were verified by the merchant device.

### BACKGROUND

### Field

This field is generally related to increasing computer, network, and data security via user generated tokens including zero-knowledge proofs.

### Related Art

In online environments, sensitive information may be communicated between entities. For example, a user logging into their bank account transmits their username and password to a bank server. Similarly, a physician at a hospital may need to communicate sensitive patient data regulated by various privacy laws. When this sensitive information is shared, there is a risk that a nefarious third party is able to decrypt, corrupt, or otherwise obtain information from the transmission. For example, a user engaged in online shopping typically inputs and transmits their credit card information to a server of an e-commerce website. While encrypted, the availability of high-performance computing resources increases the chances that hackers may attempt to decrypt or otherwise corrupt the transmitted data. Thus, transmission of this data during the transaction increases the risk of it being stolen or tampered with.

### BRIEF SUMMARY

Disclosed herein are system, apparatus, device, method and/or computer program product embodiments, and/or combinations and sub-combinations thereof, for increasing computer, network, and data security by using tokens including zero-knowledge proofs to facilitate transactions without sharing sensitive data. The zero-knowledge proof is used to prove that the prover (e.g., user) is in in possession of the sensitive data (e.g., credit card information), without having to directly share sensitive data. Upon verification of the zero-knowledge proof by a recipient (e.g., a merchant), a transaction (e.g., data transfer, purchase) may be performed between the prover and recipient.

### BRIEF DESCRIPTION OF THE DRAWINGS

The accompanying drawings are incorporated herein and form a part of the specification.

FIG. 1 depicts a block diagram of a merchant environment, according to some embodiments.

FIG. 2 depicts a block diagram of a token, according to some embodiments.

FIG. 3 depicts a flowchart illustrating a method for generating and sending a token including a zero-knowledge proof, according to some embodiments.

FIG. 4 depicts a flowchart illustrating a method for receiving and processing a token including a zero-knowledge proof, according to some embodiments.

FIG. 5 depicts a block diagram illustrating a method for utilizing tokens and zero-knowledge proofs, according to some embodiments.

FIG. 6 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for increasing computer, network, and data security by using tokens including zero-knowledge proofs to facilitate transactions without sharing sensitive data. Upon receipt and verification of both the token and zero-knowledge proof, the transaction is executed.

Current transaction systems often involve a user interacting with a client device (e.g., a laptop) to transact with a merchant. For example, the user may desire to purchase a product sold by the merchant, or may desire to access a user account maintained by the merchant. These interactions may involve the client device transmitting data to a merchant system and present various security risks. There is a risk that information a user electronically provides to a merchant will be stolen and/or corrupted by a nefarious third party. For example, a user may provide sensitive data to a merchant. In some embodiments, the sensitive data may be payment credentials (e.g., credit card number) for executing a transaction. In some embodiments, the sensitive data may be login credentials (e.g., username and password) to access a user account. However, a third party may execute a man in the middle attack and steal and/or corrupt the sensitive data. Additionally, when the sensitive data arrives at the merchant, the user is forced to rely on the merchant’s security to protect the sensitive data. The user may have no insight into the security systems (e.g., firewalls) used to protect the sensitive data once received by a merchant system. Furthermore, the user may have no insight into merchant’s data retention policy defining how long the sensitive data will be kept before deletion. Thus, the user’s sensitive data may be exploited while needlessly residing on the merchant’s system.

These problems are exacerbated in environments that use autonomous agents such as chatbots or AI assistants to perform tasks within an agentic architecture. An agentic architecture refers to the integration of autonomous software agents into the structure of systems or applications to enhance functionality, decision-making, and efficiency. In the context of online environments, these agents operate with a degree of independence, interacting with the environment, users, or other agents to complete tasks. For example, an agent may be part of a browser extension that automatically obtains and applies coupons for purchases executed within the browser.

Here, the user may describe a product they desire to purchase to the chatbot (e.g., the agent). The chatbot may perform an internet search or communicate with other chatbots to find a merchant providing the described product. However, there are risks associated with: (1) the chatbot may be unable to verify the veracity of a merchant and/or other entities it communicates with; (2) the chatbot may inadvertently supply sensitive data (e.g., payment credentials) to a nefarious third party. However, requiring the chatbot to continuously prompt the user to approve every communication is inefficient because it defeats the utility of using a chatbot for automated communications.

There are a number of stages in which agents may interact during a network transaction including a pre-purchase phase, transaction phase, and post-purchase phase.

For the pre-purchase phase, agents include recommendation agents, which may analyze user queries, preferences, browsing history, and contextual data to suggest products or services, search agents for automatically refining search queries and ranking results based on relevance, availability, and user intent, and price comparison agents that aggregate prices from multiple vendors in real time to find the best deal.

For the transaction phase, agents may include authentication agents for verifying user credentials and ensuring secure login, negotiation agents involved with offering dynamic pricing or auctions for negotiating terms or prices on behalf of users, and payment processing agents for handling payment validation, interacting with payment networks, and monitoring for fraud or anomalies.

For the post-purchase phase, agents may include order fulfillment agents coordinating with inventory systems, shipping providers, and logistics chains for delivery, customer support agents for providing automated responses to user queries or escalating issues, and feedback collection agents that prompt users to provide reviews or ratings and analyze the input for quality assurance or improvements.

The decentralized nature of agents and the number of interaction points for agents within an agentic transaction sequence present a number of security issues. For example, there is a lack of centralized oversight that governs or monitors agents that participate within a transaction. It is also a challenge to establish trust between agents when interacting and exchanging data. Agents also may communicate over potentially unsecured networks which may lead to intercepted communication, spoofing, or tampering. Finally, agents handle sensitive information such as personal details, payment credentials, and transaction history. If improperly secured, this data could be intercepted or misused.

To address such issues, systems and methods are disclosed that use tokens including zero-knowledge proofs to facilitate transactions that include agents within the transaction sequence without sharing sensitive data. Instead of sharing the sensitive data, zero-knowledge proofs are used to prove and verify that the prover has the sensitive data to execute the transaction. Using zero-knowledge proofs instead of sharing the sensitive data increases computer, network, and data security for transactions that involve agents because: (1) it removes a rogue agent’s ability to steal and/or corrupt the sensitive data during transmission; (2) it establishes a verifiable layer of trust between agents, allowing them to engage in a transaction; (3) it is a scalable solution that facilitates interaction between any number of agents; and (4) removes the need for a centralized authority to supervise (e.g., manage) the agents. Using zero-knowledge proofs instead of sharing the sensitive data also improves efficiency because it allows for verification of trust between automated AI assistants that are used to perform transactions (e.g., make purchases, transmit communications) mitigating concerns that the AI assistant will share sensitive data or be a rogue agent. Thus, using zero-knowledge proofs to execute transactions, instead of sharing sensitive data, improves at least the security and efficiency of agentic architectures.

To implement an aspect, client device generates a zero-knowledge proof. The zero-knowledge proof may be generated using sensitive data (e.g., a credit card, a password, a debit card) on the client device, such that the zero-knowledge proof is unique to the sensitive data. For example, if a user has three credit cards, the user may cause their client device to generate three zero-knowledge proofs, one for each credit card. In some embodiments, the zero-knowledge proof may be further generated using a cryptographic key issued by a server system of a financial instruction, a credential issued by the server system of a financial institution, a merchant identifier, and a purchase amount. The financial institution server system may further distribute prover kits to client devices and verifier kits to merchant systems.

The prover kits may allow the client device to generate the zero-knowledge proof, in order to prove possession of the sensitive data. The prover kit may accept inputs such as the sensitive data (e.g., credit card details), a merchant identifier, purchase amount, cryptographic key, and credentials. The cryptographic key and credentials may be reusable and issued the financial institution. The verifier kits may allow the merchant system to verify the zero-knowledge proof, thus proving that a user of the client device has possession of the sensitive data. For example, a zero-knowledge proof may be generated for a credit card owned by a user of the client device.

The user of the client device may desire to make purchase a product. The user may employ an agent (e.g., an AI assistant) on the client device as part of the purchase process. In some embodiments, the agent may be hosted on a server in communication with the client device. The user may provide a natural language description of the product to the agent. The description may include further instructions such as whether to identify a product and present it for the user’s approval, or whether to identify the product and execute a transaction as long as the cost is less than a certain amount. In response the agent may perform one or more internet searches to identify a merchant selling the product. The agent may communicate with other agents, such as agents hosted by merchants that are configured to respond to queries about the merchant’s available products. Based on the description, the agent of the client device may identify one or more products and present them to the user for selection. In some embodiments, the agent may identify a product based on the description and proceed with making the purchase.

Once a product is identified, either automatically by the agent, or through the user’s selection of the agent’s findings, the client device may generate a token. In some embodiments, the client device may cause the token to be generated by a server. The token may be formatted as JSON. In some embodiments, the user may cause the client device to generate the token. In some embodiments, the agent may generate the token. The token may include the zero-knowledge proof, a merchant identifier, an amount of money, a product, a signature, and an expiration time. The client device may generate the signature by calculating a hash value using the token contents and a private encryption key. The client device may transmit the token to a merchant system identified by the merchant identifier. In some embodiments, the client device may transmit the token to one or more agents or other networked entities, prior to the token reaching the merchant system.

The merchant system may receive the token, validate the token signature via a public key, and use the verifier kit to verify the zero-knowledge proof. The merchant system may validate the token signature using a public key. The public key may be paired with the private key used to generate the token signature. The merchant system may further verify they have the product, verify the product is less than or equal to the amount of money, and verify the current time is less than or equal to the expiration time. Once verified, the merchant system may transmit a transaction authorization message to the server system of the financial institution.

The systems and methods disclosed increase computer, network, and data security through various ways. First, sensitive data (e.g., payment credentials) does not need to be shared between the client, agents, and merchant devices. Instead, the zero-knowledge proof is used to verify that the user or agent of the client device has the sensitive data. For example, the zero-knowledge proof is used to prove that the user of the client device has the requisite funds to make a purchase. This allows an agent on the client device and an agent at a merchant to communicate and execute a transaction, without the risk that one of the agents will share sensitive data with a third party. Second, the expiration timestamp is used to limit how long the token can be used to make a purchase for. For example, the token may be valid for only 30 minutes. In contrast, a current system may solely rely on the expiration date of the payment method to time bar the purchase. For example, a current system may use the expiration date of a credit card as a time restriction on the purchase. However, the credit card may be valid for years, and thus increases the risk that the credit card will be used improperly. Incorporating a timestamp in the token reduces the risks associated with a user or agent relying on a merchant system’s security to protect their sensitive data because it is only valid until the current time matches the timestamp. Furthermore, the timestamp provides an additional security mechanism that the agents may utilize to determine whether to engage in a transaction. Current agent systems suffer from an inability to time restrict the agent behavior; there is a risk that the agents will continue communicating and execute transactions long after a user’s desired time window. In contrast, the agents described here may simply check the expiration timestamp at various phases of a transaction to determine whether to continue. This further facilitates the decentralized and secure use of agents. Third, the token is signed with an encryption key (e.g., a private key) that is unique to the user of the client device. Thus, if a malicious third party (e.g., a rogue agent) gained access to the token, signed it with a different key, the merchant device or merchant agent would detect that the token is invalid. The detection occurs based on the merchant device or merchant agent calculating a hash using the user’s public key, and detecting that the calculated hash does not match the hash appended by the malicious third party.

The systems and methods not only provides security to the merchant that the client signed the token and has funds indicated by the zero-knowledge proof, they also provide security to the client. As noted above, a server system of a financial institution may distribute verifier kits to merchants to verify the zero-knowledge proof. The financial institution may only distribute verifier kits to trustworthy merchants and/or merchants that meet certain standards/requirements. For example, kits may only be distributed to online retailers that meet certain cybersecurity requirements (e.g., encryption standards, data retention standards, data privacy standards). Thus, when the user or user’s agent engages in a transaction with a merchant or merchant agent that has the verifier kit, there is an additional layer of security built in because the merchant has already been vetted by the financial institution (e.g., kit provider) prior to receiving the kit.

The financial institution may also require that agents on the merchant’s systems meet certain requirements. For example, the financial institution may require the merchant agent to utilize certain forms of encryption. In some embodiments, the merchant agent may be interacted with via an API. Thus, encrypting the API interactions or requiring a key to access the API helps to secure the merchant agent and merchant system. Enforcing requirements on the merchant’s agent adds additional layers of trust and security when using agents to execute transactions.

Various embodiments of these features will now be discussed with respect to the corresponding figures.

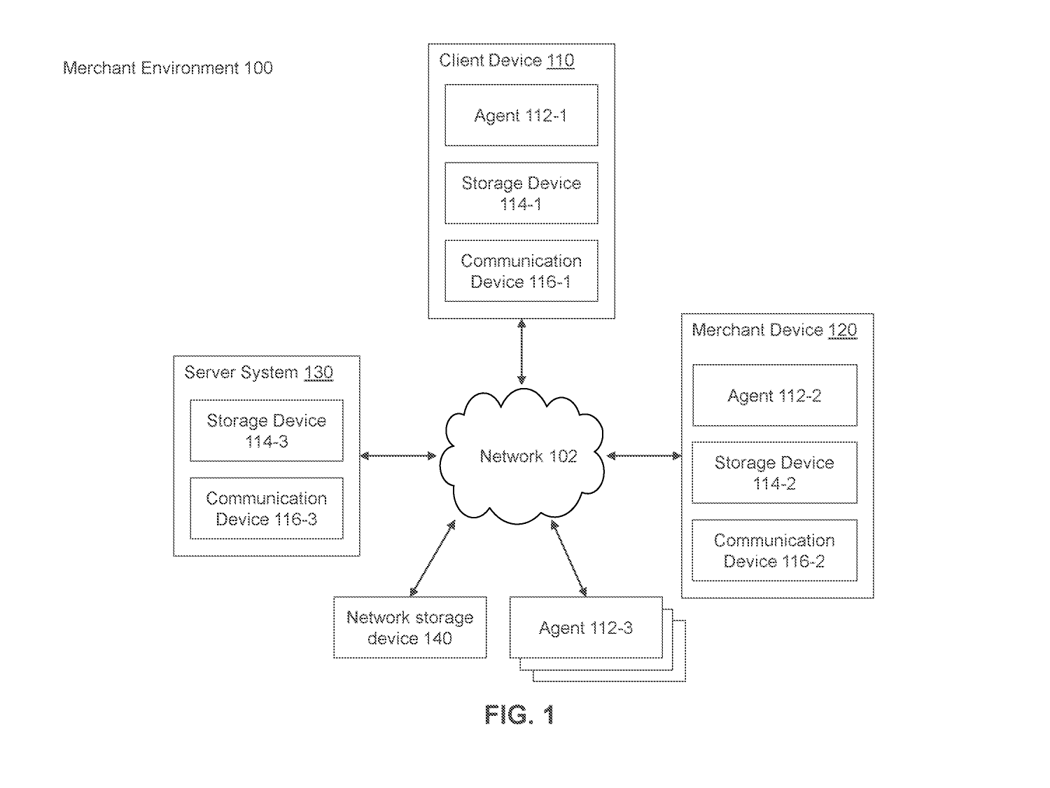

FIG. 1 depicts a block diagram of a merchant environment 100, according to some embodiments. Merchant environment 100 includes network 102, client device 110, agent 112-3, merchant device 120, server system 130, and network storage device 140.

Network 102 may be any type of computer or telecommunications network capable of communicating data, for example, a local area network, a wide-area network (e.g., the Internet), or any combination thereof. The network may include wired and/or wireless segments. In some embodiments, network 102 may be a secure network.

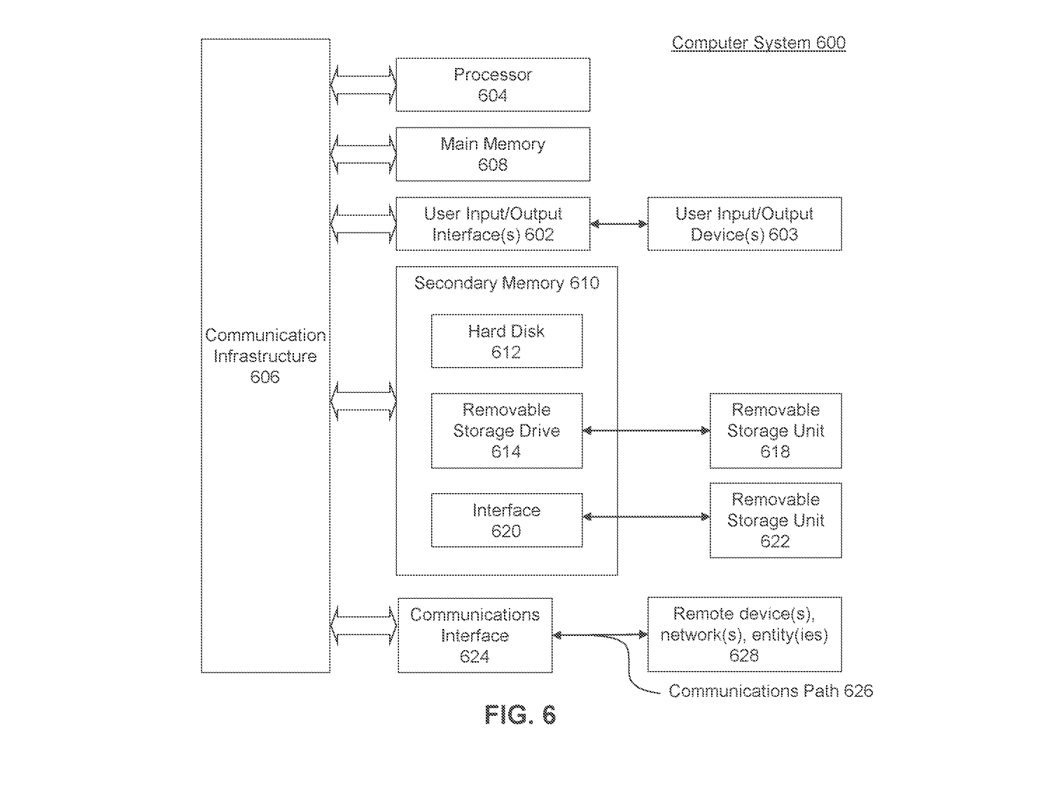

Client device 110 may be associated with a user attempting to execute a transaction with a merchant associated with merchant device 120. For example, client device 110 may attempt to make a purchase with merchant device 120. Similarly, client device 110 may attempt to access a user account by providing login credentials to merchant device 120. Client device 110 may be a computer system such as computer system 600 described with reference to FIG. 6. Client device 110 may be a client system such as a desktop workstation, laptop or notebook computer, netbook, tablet, smart phone, and/or other computing device that may be using an enterprise computing system. In some embodiments, client device 110 may be a mobile device, a web browser, and/or a wearable device (e.g., smart watch, smart glasses). Although a single client device 110 is depicted, merchant environment 100 may include any number of client devices 110.

Client device 110 may be configured to generate a zero-knowledge proof. The zero-knowledge proof may be used to prove possession of data such as a payment method or a username and password. Client device 110 may generate the zero-knowledge proof based on data (e.g., the credit card number, security code, and expiration date). In some embodiments, client device 110 may further use cryptographic credentials from a financial institution (e.g., server system 130) to generate the zero-knowledge proof. Client device 110 may generate the zero-knowledge proof via a prover kit. The prover kit may be received at client device 110 from a financial institution, such as server system 130. In some embodiments, client device 110 may input to the prover kit: (1) the sensitive data (e.g., credit card details); (2) a merchant identifier; (3) an amount of money; (4) a cryptographic key; and (5) a credential. The prover kit may output the zero-knowledge proof. For example, the user of client device 110 may desire to buy a product costing $1200 from Merchant X using a credit card. Here, client device 110 may input the credit card details, Merchant X, and $1200 into the prover kit to generate a zero-knowledge proof indicating that the credit card is sufficient to make the $1200 purchase.

Client device 110 includes agent 112-1, storage device 114-1, and communications device 116-1. Agent 112-1 may be an autonomous agent software program in connection with client device 110. Although agent 112-1 is depicted as being located on client device 110, agent 112-1 may be executing on a server, remote from client device 110. Agent 112-1 may include a machine learning model and be trained to input natural language and execute a task based on the input. In some embodiments, agent 112-1 may be a standalone executable program (e.g., an application) on client device. In some embodiments, agent 112-1 may be part of an application. For example, client device 110 may include an application provided by a merchant to browse the merchant’s products and make purchases. The merchant application may include agent 112-1. Similarly, agent 112-1 may be an extension to a browser application executing on client device 110.

A user of client device 110 may interact with agent 112-1 through a chatbot interface. The user may input natural language text and agent 112-1 may respond based on the input. For example, if agent 112-1 is a standalone app on client device 110, the user may input a query to agent 112-1 stating “Find me a personal laptop to buy with at least 16 GB of RAM and 1 TB of storage for less than $1000.” In response, agent 112-1 may execute a web-based search on network 102 to generate responses to the query. Agent 112-1 may display a list including one or more hyperlinks to products matching the user’s description.

Agent 112-1 may be configured to communicate with agent 112-2 and agent 112-3. For example, client device 110 may include agent 112-1 and merchant device 120 may include agent 112-2. Here, agents 112-1 and 112-2 may communicate via network 102. For example, the user of client device 110 may input a query to agent 112-1, and agent 112-1 may communicate the query to agent 112-2 at merchant device 120. Merchant environment 100 may include any number of agents 112-1,112-2, and 112-3.

Merchant environment 100 further includes agent 112-3. Agent 112-3 may be connected to network 102 and configured to communicate with agent 112-1 and agent 112-2. For example, agent 112-3 may be hosted by a search engine. Here, agent 112-1 may transmit a query for a product to agent 112-3. In response, agent 112-3 may execute a search for the product via the search engine, and return a result of the search to agent 112-1. Here, the result may indicate that the merchant of merchant device 120 sells the product, and may further include a merchant identifier (e.g., a domain name) to locate merchant device 120 on network 102. In some embodiments, agent 112-3 may connect agent 112-1 and agent 112-2 to further facilitate a transaction by providing agent 112-1 the address of agent 112-2 on network 102. As a result, agent 112-1 and agent 112-2 may interact to carry out a transaction. Similarly, agent 112-3 may be hosted by an inventory system used by the merchant and responsible for housing the product. Here, agent 112-1 or agent 112-2 may query agent 112-3 to determine: (1) whether the product is in stock; and (2) an estimated delivery time to receive the product at a specified address.

As will be described below, client device 110 may generate a token used to execute a transaction. Agent 112-1 may communicate the token via network 102. For example, agent 112-1 may identify a merchant website that may include a product responsive to the user’s query. The merchant website may be hosted by merchant device 120 and include agent 112-2. Here, agent 112-1 may forward the user’s query to agent 112-2 to determine whether the merchant sells a matching product. This may be faster than agent 112-1 parsing the merchant’s website to locate the product matching the query. Similarly, if agent 112-1 is integrated in the merchant’s application installed on client device 110, agent 112-1 may communicate with agent 112-2 of merchant device 120 to determine whether the merchant has a matching product. Since agent 112-1 is part of the merchant’s application, agent 112-1 may be able to obtain more information from agent 112-2 such as current inventory levels, upcoming promotions, and/or available discounts, and communicate these to the user of client device 110 via the chatbot interface.

Storage device 114-1 may be implemented using a memory storage device to store data. As will be discussed below in more detail, client device 110 may utilize a private key to sign a token. The private key may be stored at storage device 114-1 of client device 110. Storage device 114-1 may be encrypted.

Communications device 116-1 may be configured to communicate with entities on network 102. For example, client device 110 may use communications device 116-1 to communicate with agent 112-3, merchant device 120, server system 130, and network storage device 140. Communications device 116-1 may comprise any suitable network interface capable of transmitting and receiving data, such as, for example a modem, an Ethernet card, a communications port, or the like. Communications device 116-1 may be able to transmit data using any wireless transmission standard such as, for example, Wi-Fi, Bluetooth, cellular, or any other suitable wireless transmission.

Client device 110 may be configured to generate a token. In some embodiments, client device 110 may cause a server, such as server system 130, to generate the token. In some embodiments, the token may be a JavaScript Object Notation (JSON) Web Token (JWT). The token may be used to communicate the zero-knowledge proof and include information for making a purchase and/or sharing sensitive data (e.g., login credentials). The token may include the zero-knowledge proof, a product, a merchant identifier, an amount of money, and a timestamp. The token may further include a signature generated using a private key and the contents of the token.

The zero-knowledge proof may correspond to a payment method, and be used by a recipient (e.g., merchant device 120, agent 112-2) to verify that the user of client device 110 does possess the sensitive data (e.g., payment method, username/password). In some embodiments, the zero-knowledge proof may further correspond to the purchase the user of client device 110 wishes to make. As a result, client device 110 may use the prover kit to generate the zero-knowledge proof for inclusion in the token. The product may be a description of a product the user of client device 110 wishes to purchase. For example, the product may be “a laptop with 8 GB of RAM and 1 TB of storage space.” The merchant identifier may be used to identify a merchant the user of client device 110 wants to make the purchase with. For example, the merchant identifier may correspond to the merchant of merchant device 120. The merchant identifier may be any combination of alphanumeric characters. The amount of money may be an exact amount of money authorized for the transaction. For example, the user may know the exact price of the item, and use the exact price when generating the token. In some embodiments, the amount of money may be a maximum amount of money authorized for the transaction. Here, the user may provide a maximum amount of money indicating the most they are willing to spend on the product. This is beneficial in a scenario where the user utilizes agent 112-1 to locate a merchant selling the product. The timestamp may be a time at which the token is no longer valid. For example, the timestamp may indicate a time24 hours in the future from when the token was generated. Thus, the token may only be valid for the 24 hour period.

Generating the token in this manner improves security and efficiency of transactions between agent 112-1 and agent 112-2. Noted above, a user of client device 110 may input a natural language query describing a product to agent 112-1. Agent 112-1 may search network 102 for a merchant selling the product, and engage in a transaction with merchant device 120 and/or agent 112-2 at merchant device 120. Here, agent 112-1 may use the amount of money in the token as a way to filter out products that are too expensive because they’re greater than the amount of money. For example, agent 112-1 may only transact with agent 112-2 that has a product less than the amount of money indicated in the token. Similarly, agent 112-1 may use the timestamp in the token to determine when to cease operations. For example, agent 112-1 may set a timer based on the timestamp (e.g., 24 hours). At the conclusion of the timer, agent 112-1 may terminate communications with entities on network 102. Similarly, agent 112-2 may compare the time the token is received to the timestamp in the token to determine whether the token is valid. If the receipt time is later than the token timestamp, agent 112-2 may decline to transact with agent 112-1. Thus, the token acts as a decentralized mechanism to control agent 112-1 and agent 112-2.

Client device 110 may sign the token prior to transmitting it. Client device 110 may sign the token using a private key. The private key may be part of a public-private key pair. Similar to the zero-knowledge proof, the public-private key pair may be unique to the payment method. In some embodiments, the signature of the token may be represented as a hash value. In some embodiments, the hash value may be appended to the token. The private key may correspond to the payment method that: (1) is intended to be used for the purchase; and (2) corresponds to the zero-knowledge proof. As will be discussed below, a public key paired with the private key may be used to verify the token’s authenticity. For example, the public key may be used to create a hash of the token, which is compared to the hash that was appended to the token. Based on the hashes matching, the recipient (e.g., merchant device 120) may confirm that: (1) the token and data therein was not tampered with during transmission; and (2) the private key paired to the public key was used to sign the token.

In some embodiments, client device 110 may include the public key in the token. In some embodiments, client device 110 may include a key identifier corresponding to the public key to verify the token signature. The recipient (e.g., merchant device 120) may use the key identifier to locate the public key.

In some embodiments, a user of client device 110 may interact with client device 110 to cause the token generation and transmission. In some embodiments, agent 112-1 may create and/or transmit the token. For example, a user may describe a product they wish to purchase to the chatbot interface of agent 112-1, and cause client device 110 to generate a token for purchasing the product. Here, agent 112-1 may communicate with one or more merchant devices 120 via network 102 to identify a merchant device 120 with a product matching the description, and transmit the token to execute a transaction. In some embodiments, the user may describe a product they wish to purchase to the chatbot interface of agent 112-1, and agent 112-1 may locate a merchant device 120 with a product matching the description. Here, agent 112-1 may generate a notification on client device 110 including the product and merchant identifier. The user may review the notification, and cause client device 110 to generate the token. Here, the user may interact with client device 110 to send the token to merchant device 120. Similarly, the user may interact with agent 112-1, causing agent 112-1 to transmit the token to merchant device 120. The token may be transmitted from client device 110 to merchant device 120 via network 102. In some embodiments, the token may proceed to other entities on network 102 prior to reaching merchant device 120. For example, the token may be first sent to agent 112-3, and agent 112-3 may forward the token to merchant device 120. In an embodiment where agent 112-2 is executing at a server remote from merchant device 120 (e.g., at server system 130), the token may be received at agent 112-2 instead of merchant device 120.

Merchant device 120 may be any device associated with a merchant. Merchant device 120 may be a computer system such as computer system 600 described with reference to FIG. 6. Merchant device 120 may be a client system such as a desktop workstation, laptop or notebook computer, netbook, tablet, smart phone, and/or other computing device that may be using an enterprise computing system. For example, merchant device 120 may be a computer located at a merchant’s physical store. In some embodiments, merchant system 120 may be implemented using one or more servers and/or databases. In some embodiments, merchant system 120 may be implemented as an application in an enterprise computing system and/or a cloud-computing system. Here, merchant device 120 may be a server at a location separate from a physical store of the merchant. Although a single merchant device 120 is depicted, merchant environment 100 may include any number of merchant devices 120.

Merchant device 120 may be assigned a merchant identifier. Noted above, the token generated by client device 110 may include a merchant identifier. Thus, merchant device 120 may receive the token from client device 110 or agent 112-3 based on being assigned the identifier. Merchant device 120 may generate the merchant identifier. In some embodiments, server system 130 may assign the merchant identifier to merchant device.

Merchant device 120 includes agent 112-2, storage device 114-2, and communications device 116-2. Merchant device 120 may use communications device 116-2 to communicate with entities on network 102 such as client device 110 and server system 130. Agent 112-2 may be an autonomous software program, and as described above, agent 112-2 may communicate with agents 112-1 and 112-3 on network 102. Although agent 112-2 is depicted as being located on merchant device 120, agent 112-2 may be executing on a server, remote from merchant device 120.

For example, agent 112-2 may receive and respond to a query from agent 112-1. The query may be a request for a particular product, and agent 112-2 may respond indicating that the merchant of merchant device 120 sells the product. Subsequently, agent 112-2 may receive a token from agent 112-1. Agent 112-2 may verify the token by, for example, comparing the price of the product sold by the merchant to the amount of money specified in the token. Similarly, agent 112-2 may compare a time the token was received (e.g., a receipt time) to a timestamp specified in the token. If either the product price is greater than the amount of money specified in the token, or the receipt time is later than the token timestamp, agent 112-2 may refuse to transact with agent 112-1. In some embodiments, agent 112-2 may transmit a refusal message to agent 112-1 specifying the reason for the refusal such as the product is too expensive or the token is expired. Thus, as stated above, the token allows agent 112-1 and agent 112-2 to interact and transact in a secure, decentralized manner.

Merchant device 120 may directly receive the token, or agent 112-2 may receive the token. When merchant device 120 or agent 112-2 receives a token, it may identify a key used to validate the token. Noted above, client device 110 may sign the token using a private key. Merchant device 120 and/or agent 112-2 may identify the public key used to validate the signature. The token may include the public key. In some embodiments, the token may include a key identifier corresponding to the public key. Merchant device 120 may include a dictionary of public keys, and the key identifier may be an index input to the dictionary to retrieve the public key. Similarly, the public key may be stored at network storage device 140, and merchant device 120 and/or agent 112-2 may use the key identifier to retrieve the public key from network storage device 140. In some embodiments, the public key may be stored at server system 130, and merchant device 120 and/or agent 112-2 may use the key identifier to retrieve the public key from server system 130.

Once the key is identified, merchant device 120 may ensure the public key is valid. For example, merchant device 120 may query network storage device 140 to determine whether the key is valid. Network storage device 140 may maintain a list of valid public keys. Merchant device 120 may transmit a message including the public key to network storage device 140 and receive a response indicating whether the key is valid. If the key is valid, merchant device 120 may continue to process the token. Otherwise merchant device 120 may transmit a failure message to client device 110. In some embodiments, the failure message may be transmitted to agent 112-1. Similarly, merchant device 120 may query server system 130 to determine whether the public key is valid. Although described with respect to merchant device 120, agent 112-2 may perform the same steps described above.

Merchant device 120 may process the token by verifying a signature of the token and using a verifier kit to verify the zero-knowledge proof within the token. Merchant device 120 may verify the signature by calculating a hash using the contents of the token and the public key. In some embodiments, agent 112-2 may calculate the hash. If the private key corresponding to the public key was used to create the signature, and the contents of token are unchanged since it was created, the hash value generated by merchant device 120 should match the signature. Merchant device 120 may further use the verifier kit to verify the zero knowledge proof in the token. In some embodiments, agent 112-2 may further use the verifier kit to verify the zero knowledge proof. Furthermore, merchant device 120 may calculate an exact purchase price for the product described in the token. In some embodiments, agent 112-2 may calculate the exact purchase price.

In some embodiments, merchant device 120 may transmit a confirmation message to client device 110. The confirmation message may include the product and the exact purchase price. In some embodiments, client device 110 may respond with an approval or denial message. If client device 110 responds with an approval message, merchant device 120 may communicate with server system 130 to complete the transaction. Otherwise, merchant device 120 may abandon the transaction. In some embodiments, agent 112-2 may transmit the confirmation message to client device 110. The confirmation message may be received by agent 112-1 at client device 110. In some embodiments, agent 112-1 may respond based on a prior authorization input by the user of client device 110. In some embodiments, agent 112-1 may generate a notification at client device 110 requesting user input.

Server system 130 may be associated with a financial institution and/or a payment provider. Server system 130 may be configured to receive a transaction request and execute the transaction. Server system 130 may be implemented using one or more servers and/or databases. In some embodiments, server system 130 may be implemented using a computing device such as a desktop workstation, laptop or notebook computer, netbook, tablet, smart phone, and/or other computing device. In some embodiments, server system 130 may be implemented as an application in an enterprise computing system and/or a cloud-computing system. In some embodiments, server system 130 may be a computer system such as computer system 600 described with reference to FIG. 6. Although a single server system 130 is depicted, merchant environment 100 may include any number of server systems 130. Server system 130 may use communication device 116-3 to communicate with other entities on network 102 such as client device 110, merchant device 120, agent 112-3, and network storage device 140.

Server system 130 may be configured to generate a prover kit for client device 110 and a verifier kit for merchant device 120. Server system 130 may be configured to transmit the prover kits and verifier kits via network 102. For example, when a user of client device 110 activates a new payment method, client device 110 may create a new zero-knowledge proof unique to the payment method. Server system 130 may cause client device 110 to generate a public-private key pair corresponding to the payment method and zero-knowledge proof. For example, server system 130 may transmit a certificate to client device 110, and client device 110 may use the certificate to generate a public-private key pair.

Server system 130 may further manage public-private key pairs and prover/verifier kits. For example, when a user deactivates a payment method, server system 130 may deactivate the public-private key pair linked to the payment method. Similarly, when a user activates a new payment method (e.g., activates a new credit card), client device 110 may generate a new zero-knowledge proof for the new payment method. Server system 130 may generate a certificate for client device 110 to generate a new public-private key pair corresponding to the new payment method. In some embodiments, server system 130 may generate a new prover kit and verifier kits corresponding to the new zero-knowledge proof. In some embodiments, previously generated prover and verifier kits may be usable for the new zero-knowledge proof.

Server system 130 may respond to queries for status of the payment method. For example, merchant device 120 may submit a query including an identifier of a verifier kit, or a public key, to server system 130. Server system 130 may further respond whether the identifier the verifier kit and/or the public key are active. Server system 130 may store a data structure indicating whether the verifier kit and/or the public key at storage device 114-3 are active.

Server system 130 may be configured to execute a transaction. Server system 130 may receive a token from merchant device 120. The token may include, but is not limited to, the zero-knowledge proof, a merchant identifier, a purchase amount, a timestamp, a product, a signature, and a key identifier. Server system 130 may verify the signed token and verify the zero-knowledge proof included within the token. In response to the verification, server system 130 may identify the payment method corresponding to the zero-knowledge proof. As noted above, both the public-private key pair used to sign and authenticate the token, and the zero-knowledge proof correspond to a payment method (e.g., a credit card, a debit card). Here, server system 130 may use the public key to both verify the token and identify the payment method to use in the transaction. Server system 130 may identify the public key based on a key identifier in the token. The key identifier may be the public key, or may be an index value to look up the public key. For example, if the public-private key pair and zero-knowledge proof are tied to a credit card, server system 130 may: (1) identify the credit card by performing a lookup using the public key; and (2) charge the credit card with the amount provided by merchant device 120. In some embodiments, server system 130 may perform the lookup at storage device 114-3.

Server system 130 may send an acknowledgement of the transaction (e.g., a receipt). Server system 130 may send the acknowledgement to merchant device 120. Merchant device 120 may forward the receipt to client device 110. In some embodiments, server system 130 may send the acknowledgement to both client device 110 and merchant device 120.

In some embodiments, server system 130 may not execute the transaction. For example, server system 130 may be unable to verify the token signature using the public key or be unable to verify the zero-knowledge proof. For instance, the token may have expired based on the timestamp in the token compared to the time it reached server system 130. Similarly, server system 130 may detect that the payment method corresponding to the zero-knowledge proof and public key is no longer valid. For example, the user of client device 110 may have deactivated the payment method. Similarly, server system 130 may detect that the payment method is insufficient (e.g., lacks requisite funds) to pay for the product. Here, server system 130 may transmit a failure message to merchant device 120 and/or client device 110.

In some embodiments, multiple instances of server system 130 may be utilized to execute a transaction. For example, a first server system 130 may receive and validate the token. The first server system 130 may forward the token and a message indicating verification to a second server system 130. The second server system 130 may execute the transaction. This may be beneficial to perform load balancing amongst a group of server systems 130.

Network storage device 140 may be implemented using a memory storage device. In some embodiments, network storage device 140 may be a blockchain. Network storage device 140 may maintain a list of active prover/verifier kits and public keys. This is beneficial so that merchant device 120 may quickly determine: (1) which public key to use; (2) whether a public key is active; and (3) whether a zero-knowledge proof is active. Noted above, the public-private key pair may correspond to a payment method of the user of client device 110 and the zero-knowledge proof to verify the payment method. When the public key is generated, client device 110 and/or server system 130 may transmit the public key to network storage device 140 for storage. The public key may be used by merchant device 120 and/or server system 130 to validate the signature of a token.

Network storage device 140 may store verifier kits for download. This is beneficial to allow additional merchant devices 120 to verify the zero-knowledge proof of client device 110. For example, a new merchant device 120 may connect to network 102, and download a verifier kit from network storage device 140. This is beneficial to expand the number of merchant devices 120 that client device 110 may transact with.

Server system 130 and/or client device 110 may be configured to update network storage device 140. For example, server system 130 may update network storage device 140 when a new payment method is created (e.g., the user signs up for a new credit card) or when an existing payment method is deactivated. Similarly, client device 110 may update network storage device 140. For example, client device 110 may generate a new public-private key pair linked to a payment method, and transmit the public key to network storage device 140 for storage in association with the payment method.

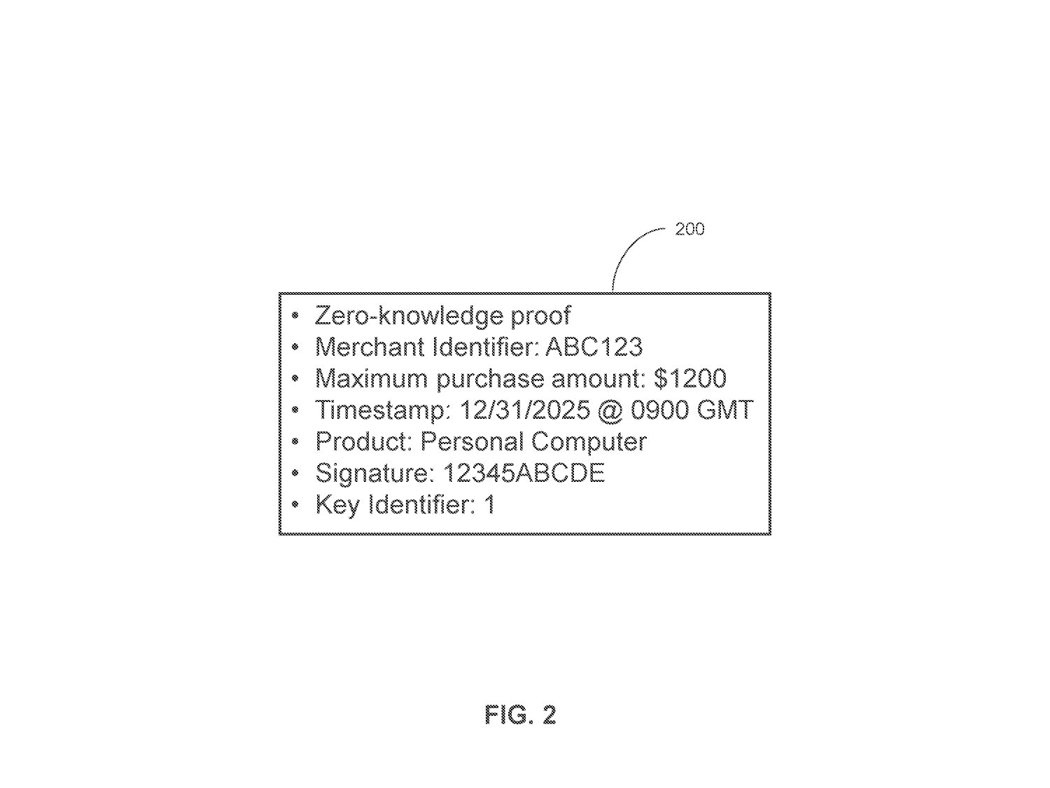

FIG. 2 depicts a block diagram of a token 200, according to some embodiments. Token 200 may be a JSON web token (JWT). Contents of token 200 may be formatted as JSON. Token 200 may be generated by client device 110. In some embodiments, agent 112-1 may generate token 200. Token 200 may include various fields including, but not limited to, a zero-knowledge proof, a merchant identifier, a purchase amount, a timestamp, a product, a signature, and a key identifier.

Noted above, the zero-knowledge proof corresponds to the payment method and proves that the user of client device 110 is in possession of the payment method. Client device 110 may generate and copy the zero-knowledge proof into token 200. The zero-knowledge proof may further prove that the payment method is linked to sufficient funds to cover a purchase of the purchase amount.

The merchant identifier may be used to identify merchant device 120. For example, the merchant identifier may be the name of the merchant, an IP address of merchant device 120, a domain name of a website hosted by merchant device 120, or any combination thereof. The merchant identifier may be the same as the merchant identifier input to the prover kit to generate the zero-knowledge proof.

The purchase amount may be an amount of money that the payment method linked to the zero-knowledge proof is capable of spending. For example, if the payment method is a credit card, the purchase amount may be the credit card’s remaining balance at the time token 200 was generated. Thus, if the credit card has a credit limit of $10,000, and when token 200 was generated the credit card had a balance of $3,000, the purchase amount would be $7,000. In some embodiments, the purchase amount may be a maximum purchase amount. This is beneficial in a scenario where client device 110 uses agent 112-1 to autonomously locate a product to purchase. Here, agent 112-1 may only identify potential products that are less than or equal to the maximum purchase amount.

In some embodiments, the purchase amount may be an exact amount of money to spend. For example, a user of client device 110 may locate a product sold by the merchant of merchant device 120. Here, the user may cause client device 110 to generate token 200, and input the exact purchase price for transmission to merchant device 120. Providing the exact amount of money is beneficial to reduce fraud because it is an unambiguous amount of money to charge to the payment method linked with token 200 and the zero-knowledge proof. In the example above, the user may identify the product and its price, calculate the necessary taxes, determine the total transaction will cost $2,025, and generate token 200 including that amount. Thus, if the user receives a debit from the merchant of merchant device 120 with a different amount, it will be very easy to contest the charge since token 200 included an exact amount of money. The amount of money may be the same amount of money input to the prover kit to generate the zero-knowledge proof.

Token 200 may further include a timestamp indicating when token 200 will expire. When merchant device 120 receives token 200, it may compare the current time to the timestamp in token 200 to determine whether token 200 has expired. If token 200 has expired, merchant device 120 may transmit a message indicating that token 200 has expired to client device 110. Otherwise, merchant device 120 may process the information in token 200. Similarly, server system 130 may compare the current time to the timestamp in token 200 to determine whether token 200 has expired.

Token 200 may also include a product. The product may be an item and/or service that the user of client device 110 desires to purchase from merchant device 120. In some embodiments, the product may be an exact model (e.g., ABC Laptop Model 123). In some embodiments, the product may be a description provided by the user (e.g., personal laptop with 8 GB of RAM). This may be beneficial in a scenario where the user uses agent 112-1 to locate a merchant that sells a product matching the description.

Token 200 may further include a signature. The signature may be used to prove the identity of the signatory (e.g., the user of client device 110). Client device 110 may generate the signature by signing the token using a private key. For example, client device 110 may input its private key and the data of the token 200 into a hash function. The private key may only be known by client device 110. In some embodiments, agent 112-1 may generate the signature using the private key and data of token 200. As noted above, the private key may be paired with a public key. The public key may be accessible by entities on network 102. The signature may be any combination of alphanumeric characters.

When an entity such as merchant device 120 receives token 200, they may confirm that the private key of client device 110 signed token 200, and that the data of token 200 has not been corrupted by using the public key corresponding to the private key. For example, merchant device 120 may use the public key to generate a hash of token 200. Merchant device 120 may compare the hash value generated using the public key to the signature (e.g., hash value) provided in token 200. If token 200 was in fact signed by the private key, and no data has changed since token 200 was created, the hash values will match. In some embodiments, agent 112-2 at merchant device 120 may confirm that the private key of client device 110 signed token 200, and that the data of token 200 has not been corrupted.

Token 200 may further include a key identifier. The key identifier may be used to communicate the public key to be used to validate token 200. In some embodiments, the key identifier may be the public key. In some embodiments, the key identifier may be an index value used to identify the public key. For example, the key identifier may be the index of the public key stored at merchant device 120, server system 130, and/or network storage device 140.

In some embodiments, token 200 may be destroyed after use. For example, once a transaction using token 200 is completed, each entity may delete its copy of token 200. Noted above, server system 130 may generate and send a receipt to merchant device 120 and/or client device 110 indicating completion of the transaction. Once server system 130 generates the receipt, it may delete token 200. In response to receiving the receipt, merchant device 120 and/or client device 110 may delete one or more stored copies of token 200 (e.g., at storage device 114-1, at storage device 114-2). Token 200 may also be deleted if the transaction cannot be completed. For example, if merchant device 120 and/or server system 130 are unable to validate the zero-knowledge proof and/or the signature of token 200 the transaction may be abandoned. The entity abandoning the transaction (e.g., merchant device 120, server system 130) may transmit a failure message to entities on network 102 (e.g., client device 110) and delete token 200. Entities receiving the failure message (e.g., client device 110) may also delete token 200. Similarly, token 200 may be deleted at the expiration time. For example, merchant device 120 may periodically compare a current time to the timestamp in token 200. Once the current time is greater than or equal to the timestamp in token 200, merchant device 120 may delete token 200. Similarly, agent 112-2 may compare a current time to the timestamp in token 200 and delete token 200 upon expiration.

Use of token 200 further improves computer, data, and network security. Noted above, token 200 includes the zero-knowledge proof to prove possession of the payment method, without having to share details of the payment method. However, it’s possible that the zero-knowledge proof may be stolen and propagated in an attempt to impersonate the user. Token 200 further protects computer, data, and network security by first including a timestamp. Thus, even if a malicious third party somehow gains access to token 200, they would be unable to use it past the timestamp. Additionally, token 200 is signed with a private key that is unique to the user of client device 110. Thus, if a malicious third party gained access to token 200, signed it with a different key, merchant device 120 would detect that token 200 is invalid because the hash that merchant device 120 calculates using the user’s public key would not match the hash appended by the malicious third party

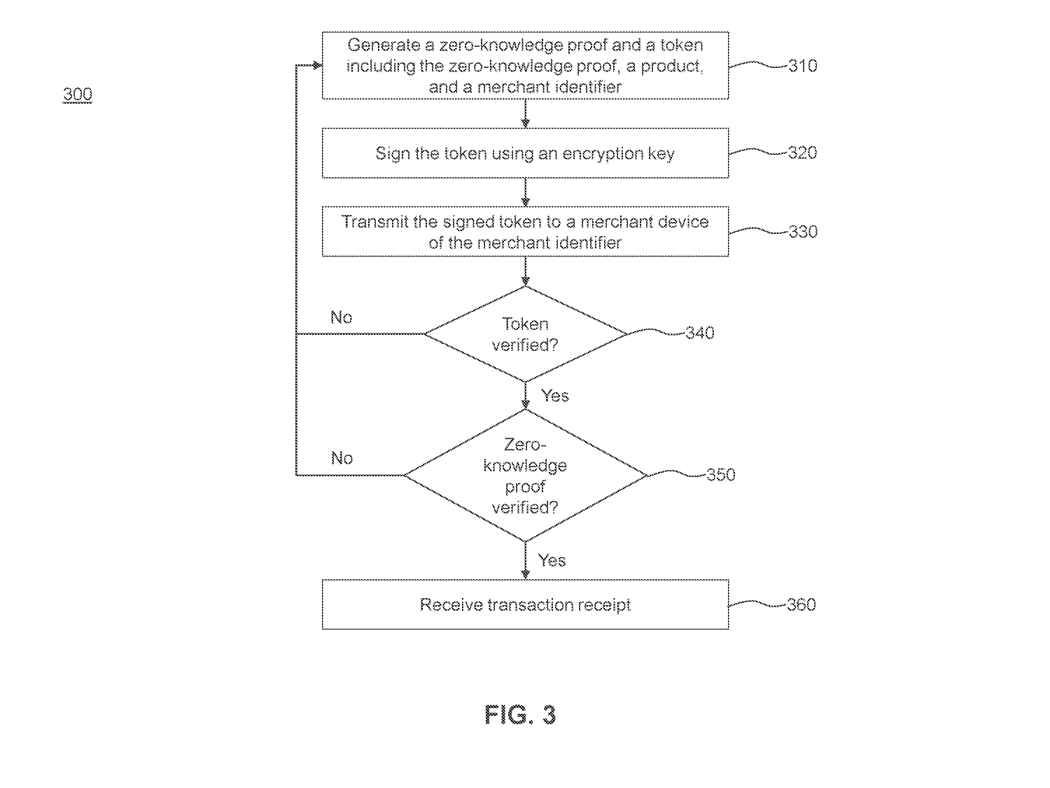

FIG. 3 depicts a flowchart illustrating a method for generating and sending a token including a zero-knowledge proof, according to some embodiments. Method 300 shall be described with reference to FIG. 1, however, method 300 is not limited to that example embodiment.

In an embodiment, client device 110 may utilize method 300 to generate a token including a zero-knowledge proof to execute a transaction. Based on verification of the token and the zero-knowledge proof, the transaction is executed. The foregoing description will describe an embodiment of the execution of method 300 with respect to client device 110. While method 300 is described with reference to client device 110, method 300 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof. For example, method 300 may be executed via agent 112-1 of client device 110.

It is to be appreciated that not all steps may be needed to perform the disclosure provided herein. Further, some of the steps may be performed simultaneously, or in a different order than shown in FIG. 3.

At 310, client device 110 generates a zero-knowledge proof and token including the zero-knowledge proof, a product, and a merchant identifier. The token may further include a purchase amount, a timestamp, and a key identifier. The token may be token 200. In some embodiments, client device 110 may use a prover kit to generate the zero-knowledge proof for inclusion in the token (e.g., token 200). Client device 110 may input details of the payment method, the merchant identifier, the purchase amount, and a cryptographic key to the prover kit, and the prover kit may output the zero-knowledge proof. In some embodiments, a user of client device 110 may utilize client device 110 to generate token 200. In some embodiments, agent 112-1 at client device 110 may generate token 200 in response to receiving a query from the user of client device 110 and identifying a product sold by merchant device 120 matching a description in the query.

At 320, client device 110 signs the token using an encryption key. As noted above, the encryption key may be a private key part of a public-private key pair. The private key may only be known to client device 110. The private key may be unique to a payment method of the user of client device 110. Client device 110 may sign the token by inputting the contents of the token and the private key into a hash function. Client device 110 may append the signature to the token.

At 330, client device 110 transmits the signed token 200 to merchant device 120. Client device 110 may identify merchant device 120 using the merchant identifier. The merchant identifier may be the name of the merchant, an IP address of merchant device 120, a domain name of a website hosted by merchant device 120, or any combination thereof. In some embodiments, client device 110 may transmit token 200 to one or more entities on network 102, prior to token 200 reaching merchant device 120. For example, client device 110 may transmit token 200 to agent 112-3, and agent 112-3 may forward token 200 to merchant device 120.

At 340, client device 110 determines whether token 200 was verified. Merchant device 120 may use the signature of token 200 to verify token 200. Noted above, the signature may be a hash, generated by the private key of client device 110 and the contents of token 200. To verify token 200, merchant device 120 may calculate a hash of token 200 using the public key of client device 110. Token 200 may include the public key. In some embodiments, token 200 may include a key identifier indicating where to locate the public key. For example, the key identifier may be a location on storage device 114-2 at merchant device 120. Similarly, the key identifier may be a location on network storage device 140 and/or server system 130. If the hash values match, merchant device 120 may transmit a message to client device 110 that it successfully verified (e.g., authenticated) token 200. Otherwise, merchant device 120 may transmit a message to client device 110 that it was unable to verify token 200. Merchant device 120 may further verify token 200 by comparing the timestamp in token 200 to a current time. If the current time is less than the time stamp in token 200, merchant device 120 may transmit a message to client device 110 that it successfully verified (e.g., authenticated) token 200. Otherwise, merchant device 120 may transmit a message to client device 110 that it was unable to verify token 200. If token 200 was verified, method 300 proceeds to 350, otherwise method 300 returns to 310.

At 350, client device 110 determines whether zero-knowledge proof was verified. As noted above, merchant device 120 may use the verifier kit to verify the zero-knowledge proof included in token 200. Merchant device 120 may transmit a result to client device 110 indicating whether it validated the zero-knowledge proof. If the zero-knowledge proof was not verified, method 300 returns to 310. If the zero-knowledge proof was verified, method 300 proceeds to 360.

At 360, client device 110 receives a transaction receipt. Client device 110 may receive the transaction receipt from merchant device 120 and/or server system 130. Client device 110 may receive the transaction receipt in response to a transaction being executed. For example, once merchant device 120 verifies token 200 and the zero-knowledge proof, merchant device 120 may transmit a transaction authorization request to server system 130. Server system 130 may similarly verify token 200, the zero-knowledge proof, and then execute the transaction. The transaction may be executed according to the contents of token 200. For example, the transaction may be for an amount of money less than or equal to the amount of money in token 200. The transaction may be for a product and/or service described in token 200. The amount of money may be paid to the merchant identified by the merchant identifier in token 200. The payment method used may be the payment method tied to the zero-knowledge proof and the public-private key pair. Client device 110 may delete the zero-knowledge proof and token 200 in response to receiving the transaction receipt.

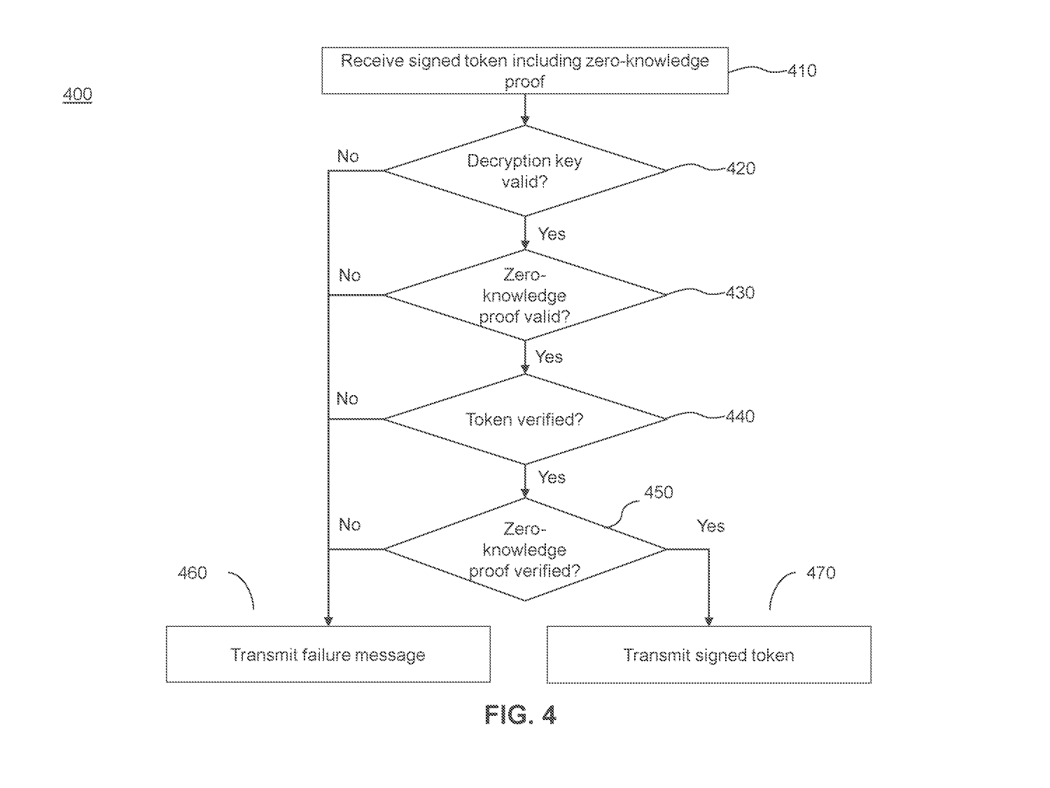

FIG. 4 depicts a flowchart illustrating a method 400 for receiving and processing a token including a zero-knowledge proof. Method 400 shall be described with reference to FIG. 1, however, method 400 is not limited to that example embodiment.

The foregoing description will describe an embodiment of the execution of method 400 with respect to merchant device 120. While method 400 is described with reference to merchant device 120, method 400 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof. For example, method 400 may be executed by server system 130. Similarly, method 400 may be executed by agent 112-2 at merchant device 120.

It is to be appreciated that not all steps may be needed to perform the disclosure provided herein. Further, some of the steps may be performed simultaneously, or in a different order than shown in FIG. 4.

At 410, merchant device 120 receives a signed token including a zero-knowledge proof. The token may be token 200. Token 200 may further include a merchant identifier, a purchase amount, a timestamp, a product, a key identifier, and a signature. The merchant identifier may correspond to the merchant of merchant device 120.

At 420, merchant device 120 determines whether the decryption key is valid. Merchant 120 may identify the decryption key using the key identifier in token 200. In some embodiments, the key identifier may be the decryption key (e.g., a public key). In some embodiments, the key identifier may be an index or other value to locate the decryption key. For example, the key identifier may be an index of a dictionary of keys at merchant device 120, server system 130, and/or network storage device 140. The decryption key may be a public key corresponding to a private key used to generate the signature of token 200. Merchant device 120 may query server system 130 and/or network storage device 140 to determine whether the decryption key is valid. For example, the decryption key may be valid until the owner of the encryption key (e.g., private key) deactivates the payment method linked to the decryption key. Similarly, the owner (e.g., user) may replace the public-private key pair linked to the payment method with a new public-private key pair. In response, the public key (e.g., the decryption key) may be marked invalid. The status (e.g., valid, invalid) of the decryption key may be stored at merchant device 120, server system 130, and/or network storage device 140. If the decryption key is valid, method 400 continues to 430, otherwise method 400 continues to 460.

At 430, merchant device 120 determines whether the zero-knowledge proof is valid. Similar to the decryption key, merchant device 120 may query server system 130 and/or network storage device 140 to determine whether the zero-knowledge proof is valid. The zero-knowledge proof may be valid until the user deactivates the payment method linked to the zero-knowledge proof. When the payment method is deactivated, the zero-knowledge proof may be marked invalid. Similarly, a new zero-knowledge proof may be generated to replace the existing zero-knowledge proof. In response, the existing zero-knowledge proof may be marked invalid. If the zero-knowledge proof is valid, method 400 continues to 440, otherwise method 400 continues to 460.

At 440, merchant device 120 verifies token 200. Merchant device 120 may first verify token 200 using the timestamp in token 200. Noted above, token 200 includes a timestamp indicating when token 200 is no longer valid. Here, merchant 120 may compare a current time to the timestamp of token 200. If the current time is less than or equal to the timestamp of token 200, merchant device 120 may continue to attempt to verify token 200. Otherwise, method 400 continues to 460. Merchant device 120 may further verify token 200 using the signature. Noted above, the signature may be a hash value created using a private key of client device 110 and the contents of token 200. Merchant device 120 may calculate a hash of token 200 using the public key identified at 420, and the contents of token 200. If the hash value calculated by merchant device 120 matches the signature, merchant device 120 verifies token 200, and method 400 continues to 450. Otherwise method 400 continues to 460.

At 450, merchant device 120 verifies the zero-knowledge proof. Merchant device 120 verifies the zero-knowledge proof by executing a function included in the zero-knowledge proof. Merchant device 120 may use a verifier kit to verify the zero-knowledge proof. If merchant device 120 verifies the zero-knowledge proof, method 400 continues to 470, otherwise method 400 continues to 460.

At 460, merchant device 120 transmits a failure message to client device 110. Merchant device 120 may construct the failure message and include a reason including, but not limited to: (1) invalid decryption key; (2) invalid zero-knowledge proof; (3) failure to verify token; and (4) failure to verify zero-knowledge proof.

At 470, merchant device 120 transmits token 200. Merchant device 120 may transmit token 200 to server system 130 in order to continue the transaction.

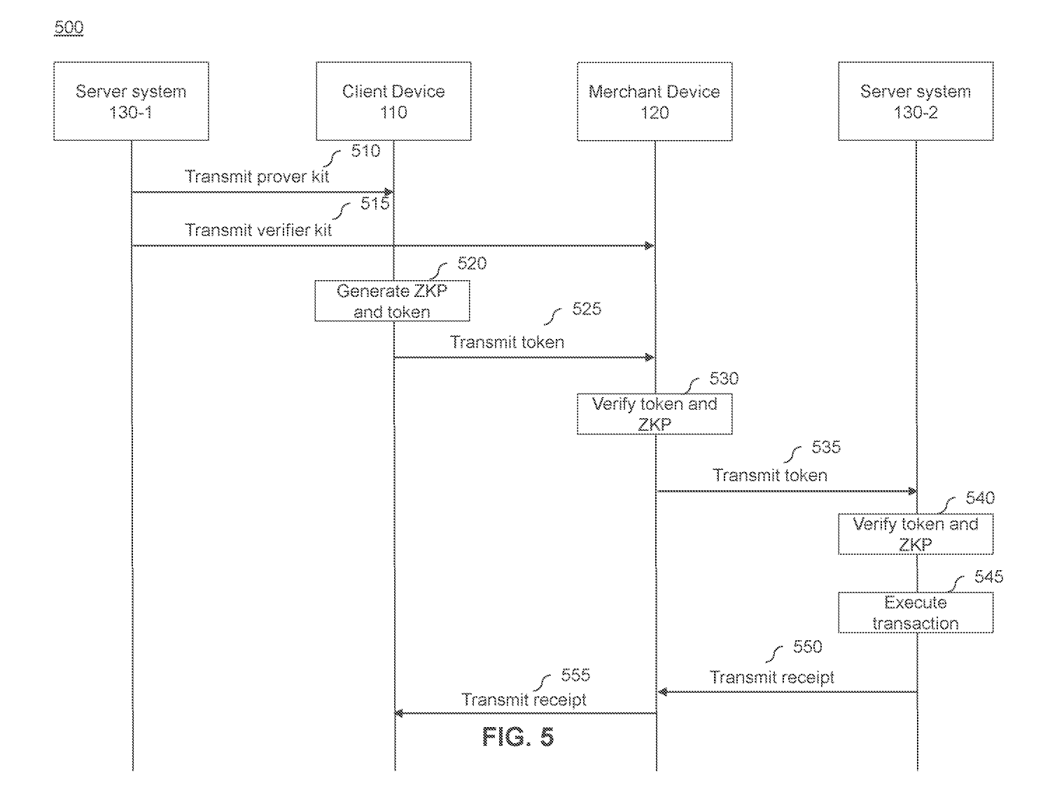

FIG. 5 depicts a block diagram illustrating a method 500 for utilizing tokens and zero-knowledge proofs, according to some embodiments. Method 500 shall be described with reference to FIG. 1, however, method 500 is not limited to that example embodiment.

The foregoing description will describe an embodiment of the execution of method 500 with respect to client device 110, merchant device 120, and server system 130. While method 500 is described with reference to client device 110, merchant device 120, and server system 130, method 500 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof. For example, while method 500 depicts two instances of server system 130, method 500 may be executed using a single server system 130. Similarly, method 500 may be executed using agent 112-1 at client device 110 and agent 112-2 at merchant device 120.

It is to be appreciated that not all steps may be needed to perform the disclosure provided herein. Further, some of the steps may be performed simultaneously, or in a different order than shown in FIG. 5.

At 510, server system 130-1 transmits a prover kit to client device 110. Server system 130-1 may be a financial institution (e.g., payment provider). A user of client device 110 may have a payment method (e.g., credit card) issued by the financial institution of server system 130-1. The prover kit may be configured to allow client device 110 to generate a zero-knowledge proof. In some embodiments, server system 130-1 may transmit the prover kit once the payment method is activated. For example the payment method may be a credit card. The user of client device 110 may communicate with server system 130-1 to activate the credit card. Server system 130-1 may detect the credit card’s activation, generate a prover kit, and transmit the prover kit to client device 110.

At 515, server system 130-1 transmits a verifier kit to merchant device 120. As noted above, the verifier kit may be used to verify a zero-knowledge proof included within a token, such as token 200. Server system 130-1 may transmit a verifier kit to a predefined list of registered merchant devices 120. For example, the financial institution of server system 130-1 may periodically evaluate the computer, network, and data security implementations of a merchant and its merchant device 120. For example, the financial institution of server system 130-1 may evaluate the encryption standards, firewalls, and data retention policies utilized by merchant device 120. In some embodiments, the financial institution may utilize a third party to perform the evaluation. Based on the computer, network, and data security implementations, server system 130-1 may consider merchant device 120 trusted, and transmit a verifier kit to merchant device 120. This evaluation provides trust between client device 110 and merchant device 120 because it reduces the risk that client device 110 may transact with an untrusted party.

In some embodiments, server system 130-1 may remove merchant device 120 from the predefined list of registered merchant devices 120. For example, if the merchant of merchant device 120 has a data breach, or is the subject of a ransomware attack, server system 130-1 may: (1) remove merchant device 120 from the predefined list of registered merchant devices 120; (2) deactivate the verifier kit transmitted to merchant device 120; and (3) generate new prover and verifier kits. Server system 130-1 may further transmit a message to client device 110 to generate a new zero-knowledge proof. Generating a new zero-knowledge proof ensures that a nefarious third party is unable to take advantage of the old zero-knowledge proof.

At 520, client device 110 generates a zero-knowledge proof and a token. Client device 110 may generate the zero-knowledge proof by inputting payment method details (e.g., credit card number, security code, and expiration date), a merchant identifier, purchase amount, cryptographic key, and credential to the prover kit. The cryptographic key and credential may be reusable and issued by server system 130. The prover kit may output the zero knowledge proof.

The token may be token 200. Token 200 may be a JSON web token. The token may include the zero-knowledge proof generated by the prover kit. Client device 110 may generate the zero-knowledge proof by inputting payment method details, a merchant identifier, purchase amount, and cryptographic key to the prover kit. The prover kit may output the zero knowledge proof. The token may further include the merchant identifier, a product, the purchase amount, a timestamp, a signature, and a key identifier. The merchant identifier may be used to identify and locate merchant device 120 on network 102. The product may be a description of a product that a user of client device 110 wishes to purchase. The purchase amount may be an exact amount of money to use in a transaction to purchase the product. In some embodiments, the purchase amount may be a maximum amount of money the user of client device 110 has authorized to spend on the product. The timestamp may be a date/time at which the token expires. Once expired, a transaction based on the token may no longer take place. The signature may be a hash value generated using a private key of client device 110 and the contents of the token. The key identifier may be: (1) a public key corresponding to the private key; or (2) an identifier used to locate the public key. For example, the key identifier may be the index of a key dictionary, where the value corresponding to the index is the public key. The key dictionary may be located at merchant device 120, server system 130, network storage device 140, or any combination thereof.

In some embodiment, a user of client device 110 may generate the token. In some embodiments, agent 112-1 of client device 110 may generate the token. As noted above, agent 112-1 may be an autonomous software program on client device 110. A user of client device 110 may interact with agent 112-1 through a chatbot interface. The user may describe a product and/or service they wish to purchase, and agent 112-1 may locate a merchant of merchant device 120 meeting the description. In response, agent 112-1 may generate the token.

At 525, client device 110 transmits the token to merchant device 120. Client device 110 may transmit the token via network 102. In some embodiments, agent 112-1 at client device 110 may transmit the token to merchant device 210. In some embodiments, client device 110 may only transmit the token to a next entity (e.g., agent 112-3). As a result, the next entity may be responsible for forwarding the token to merchant device 120.

At 530, merchant device 120 verifies the token and the zero-knowledge proof. Merchant device 120 may verify the token by comparing a current time (e.g., token receipt time) to a timestamp in the token. If the current time is later than the timestamp in the token, merchant device 120 may transmit a failure message to client device 110. Merchant device 120 may further verify the token by evaluating the signature of the token. Merchant device 120 may use the key identifier to obtain a public key corresponding to the private key of client device 110 used to generate the signature. Merchant device 120 may use the public key and contents of the token to generate a hash value. Merchant device 120 may verify the token by determining that the hash value matches the signature appended to the token. If merchant device 120 fails to verify the token signature, merchant device 120 may transmit a failure message to client device 110. Merchant device 120 may use its verifier kit to verify the zero-knowledge proof. If merchant device 120 fails to verify the zero-knowledge proof, merchant device 120 may transmit a failure message to client device 110.

At 535, merchant device transmits the token to server system 130-2. Merchant device 120 may transmit the token via network 102. In some embodiments, agent 112-2 at merchant device 120 may transmit the token. In some embodiments, merchant device 120 may include an exact purchase amount to server system 130-2. As noted above, the token may include a maximum purchase amount indicating an amount of money the user of client device 110 has authorized for use. Merchant device 120 may identify the product corresponding to the product described in the token, and calculate an exact purchase price for the product. Merchant device 120 may include the exact purchase price in its message to server system 130-2 so that server system 130-2 may execute the transaction.

At 540, server system 130-2 verifies the token and the zero-knowledge proof. Server system 130-2 may perform the same steps as merchant device 120 to verify the token and zero-knowledge proof. Server system 130-2 may further confirm an amount of money specified by merchant device 120 is less than or equal to an amount of money listed in the token. Noted above, merchant device 120 may calculate an exact purchase amount, and provide it along with the token to server system 130-2. Here, server system 130-2 may verify that the amount calculated by merchant device 120 is less than or equal to the amount listed by the user in the token.

At 545, server system 130-2 executes the transaction in response to the verification. Server system 130-2 may identify the amount of money of the transaction based on a message from merchant device 120. Server system 130-2 may use the public key, identified by the key identifier, to determine which payment method to use to execute the transaction. Server system 130-2 may be affiliated with the financial institution that issued and manages the payment method linked to the zero-knowledge proof and public-private key pair. Thus, server system 130-2 may include a mapping from the public key to the payment method. For example, server system 130-2 may include a dictionary mapping the public key to the credit card of the user of client device 110. As a result, server system 130-2 may charge the credit card according to the amount of money specified by merchant device 120.

At 550, server system 130-2 transmits a receipt to merchant device 120. The receipt may include a time of purchase, a purchase amount, and a product.

At 560, server system 130-2 transmits a receipt to client device 110. The receipt may include a time of purchase, a purchase amount, and a product.

Once the transaction is executed and receipts transmitted, each entity may delete the token so that it cannot be reused. For example, once server system 130-2 transmits the receipts to client device 110 and merchant device 120, it may delete the token. Similarly, client device 110 and merchant device 120 may delete the token upon obtaining the receipt. Client device 110 may further delete the zero-knowledge proof generated and input to the token.

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (e.g., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/ any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, the method comprising:
generating, by a client device, a token comprising a product, a merchant identifier, a maximum purchase amount, an expiration timestamp, and a zero-knowledge proof,
wherein the zero-knowledge proof is unique to a payment method of a user of the client device,
wherein the zero-knowledge proof proves that the payment method is sufficient to purchase the product with an amount of funds less than or equal to the maximum purchase amount, and
wherein the expiration timestamp is a date and time indicating when the token expires;
signing, by the client device, the token using an encryption key of the user;
transmitting, by an autonomous agent software program executing on the client device via a communications network, the signed token to a merchant device identified using the merchant identifier; and
receiving, by the client device via the communications network, a result indicating whether the zero-knowledge proof was verified by the merchant device.

2. The computer implemented method of claim 1, wherein the result indicates the zero-knowledge proof was verified by the merchant device, further comprising:
approving, by the client device, a purchase of the product using the payment method;
executing, by a server system, the purchase of the product using the payment method based on the signed token; and
transmitting, by the server system, a receipt to the client device indicating the purchase was executed.

3. The computer implemented method of claim 1, wherein the encryption key is a private key, wherein the private key is unique to the user, wherein the private key is unique to the payment method, and wherein the private key has a corresponding public key.

4. The computer implemented method of claim 3, wherein the public key is stored on a blockchain on the communication network, and wherein the server system identifies the payment method using the public key.

5. The computer implemented method of claim 1, wherein the result indicates the merchant device was unable to verify the zero-knowledge proof based on a receipt timestamp later than the expiration timestamp.

6. The computer implemented method of claim 1, wherein the result indicates the merchant device was unable to verify the zero-knowledge proof based on a determination that the payment method is inactive.

7. The computer implemented method of claim 1, wherein the signed token is transmitted to an autonomous agent software program executing on the merchant device.

8. The computer implemented method of claim 1, wherein the token is a JavaScript Object Notation (JSON) web token.

9. The computer implemented method of claim 1, wherein the payment method is a first payment method, further comprising:
generating, by the client device, a second zero-knowledge proof in response to the user of the client device registering a second payment method with the server system.

10. A system, comprising:
a memory; and
at least one processor coupled to the memory and configured to:
generate a token comprising a product, a merchant identifier, a maximum purchase amount, an expiration timestamp, and a zero-knowledge proof,
wherein the zero-knowledge proof is unique to a payment method of a user of the client device,
wherein the zero-knowledge proof proves that the payment method is sufficient to purchase the product with an amount of funds less than or equal to the maximum purchase amount,
wherein the expiration timestamp is a date and time indicating when the token expires, and
wherein the token is generated through a chatbot interface with an autonomous agent software program;
sign the token using an encryption key of the user;
transmit, by the autonomous agent software program via a communications network, the signed token to a merchant device identified using the merchant identifier; and
receive, via the communications network, a result indicating whether the zero-knowledge proof was verified by the merchant device.

11. The system of claim 10, wherein the result indicates the zero-knowledge proof was verified by the merchant device, and wherein the at least one processor is further configured to:
approve, a purchase of the product using the payment method; and
in response to the approval, receive a receipt of the purchase based on a server system using the payment method identified by the signed token to execute the purchase.

12. The system of claim 10, wherein the encryption key is a private key, wherein the private key is unique to the user, wherein the private key is unique to the payment method, and wherein the private key has a corresponding public key.

13. The system of claim 12, wherein the public key is stored on a blockchain on the communication network, and wherein the server system identifies the payment method using the public key.

14. The system of claim 10, wherein the result indicates the merchant device was unable to verify the zero-knowledge proof based on a receipt timestamp later than the expiration timestamp.

15. The system of claim 10, wherein the signed token is transmitted to an autonomous agent software program executing on the merchant device.

16. A non-transitory computer-readable device having instructions stored thereon that, when executed by at least one computing device, cause the at least one computing device to perform operations comprising:
generating a token comprising a product, a merchant identifier, a maximum purchase amount, an expiration timestamp, and a zero-knowledge proof,
wherein the zero-knowledge proof is unique to a payment method of a user of the client device,
wherein the zero-knowledge proof proves that the payment method is sufficient to purchase the product with an amount of funds less than or equal to the maximum purchase amount, and
wherein the expiration timestamp is a date and time indicating when the token expires;
signing the token using an encryption key of the user;
transmitting, by an autonomous agent software program via a communications network, the signed token to a merchant device identified using the merchant identifier; and
receiving, via the communications network, a result indicating whether the zero-knowledge proof was verified by the merchant device.

17. The non-transitory computer-readable device of claim 16, wherein the result indicates the zero-knowledge proof was verified by the merchant device, the operations further comprising:
approving, by the client device, a purchase of the product using the payment method; and
in response to the approval, receiving, by the client device, a receipt of the purchase based on a server system using the payment method identified by the signed token to execute the purchase.

18. The non-transitory computer-readable device of claim 16, wherein the encryption key is a private key, wherein the private key is unique to the user, wherein the private key is unique to the payment method, and wherein the private key has a corresponding public key.

19. The non-transitory computer-readable device of claim 18, wherein the public key is stored on a blockchain on the communication network, and wherein the server system identifies the payment method using the public key.

20. The non-transitory computer-readable device of claim 16, wherein the result indicates the merchant device was unable to verify the zero-knowledge proof based at least on a receipt timestamp later than the expiration timestamp or a determination that the payment method is inactive.
